(19) United States
(12) Patent Application Publication
(10) Pub. No.: US 2010/0127500 A1
(43) Pub. Date: May 27, 2010

(54) Method and apparatus for energy harvesting from ocean waves

(76) Inventor: Yingchen Yang, Chicago, IL (US)

Correspondence Address: Anne McGovern Burkhart;Suite 2040, 134 N. LaSalle, Chicago, IL, 60602, US

(21) Appl. No.: 12/315,043

(22) Filed: Nov. 25, 2008

(51) Int. Cl. F03B 13/20

(52) U.S. Cl. 290/53

(57) ABSTRACT

A wave energy converter includes a buoy having an interior. The buoy is adapted and constructed to float on a body of fluid. At least one stator is fixed to a surface of the interior of the buoy. At least one rotor is mounted for oscillatory movement in the buoy interior at a location inside the at least one stator. The at least one rotor and the at least one stator are separated by a very small gap to maximize energy production efficiency. At least one rotation-retarding unit is provided. The at least one rotation-retarding unit is connected to the at least one rotor. When the buoy is placed in a body of water in which wave action is present, the motion of the waves causes relative oscillation between the at least one rotor and the at least one stator to generate energy.

### CROSS REFERENCE TO RELATED APPLICATIONS

None

### STATEMENT AS TO RIGHTS TO INVENTIONS MADE UNDER FEDERALLY-SPONSORED RESEARCH AND DEVELOPMENT

None

### FIELD OF THE INVENTION

This invention relates to wave energy converters (WEC), or more specifically to electrical generators that harvest energy from ocean waves by using wave-riding buoys.

### DESCRIPTION OF RELATED ART

This invention relates to wave energy converters (WEC), or more specifically to electrical generators that harvest energy from ocean waves by using wave-riding buoys.

Ocean waves are an underutilized means of energy production. The total estimated power released by ocean waves is about 90,000 TW; that is in contrast to an averaged total power consumption of 15 TW worldwide in 2004. Ocean waves provide more consistent energy flux with much higher power intensity than winds. Scientists and engineers have been exploring ways to harvest energy from ocean waves for years. Numerous patents were granted worldwide as many universities and companies began to develop prototypes of renewable energy systems. Unfortunately, the majority of these systems were soon proven to be unrealistic and unprofitable. While pursuing commercialization, wave energy systems are often hindered by various facts. Among them, the extremely high installation cost and maintenance cost are the two major killers. In this hostile, salt-laden ocean environment, simplicity and reliability become leading design criteria.

In general, WECs can be categorized into shoreline (e.g., www.wavegen.co.uk) and offshore systems according to the deployment locations, with over 90% falling into the offshore category. The offshore WECs can be further categorized into free-floating (with flexible moorings, e.g., www.pelamiswave.com) and tight-fastening (to the seabed, e.g., www.waveswing.com, or to a above-surface platform, e.g., www.wavestarenergy.com). Among a huge variety of WEC designs, a free-floating device with its buoy isolating all the other parts from seawater is of significant advantages over others. For such a design, there are no infrastructure needs for installation, either onshore or offshore. There are no seabed mooring needs for power generation, except for anchoring it from drifting away. There are no water sealing and corrosion concerns since the only part that is in contact with seawater is the hull of the buoy. To date only two designs almost possessed all these features. One was realized by Ocean Energy (www.oceanenergy.ie), the other was by Teledyne Scientific & Imaging LLC (www.stormingmedia.us/19/1986/A198674.html).

The Ocean Energy device works on the principle of oscillating water column. The air contained in a plenum chamber is pumped out and drawn in through the turbine duct by the change of water level within the device that is cuased by the wave motion. Such air flow in the turbine duct drives the turbine to generate electricity. Although in this design the turbine and some other moving parts are above the waterline, water sealing and corrosion proofing are still indispensable due to inevitable water splash in mild weather and flooding in severe weather. In contrast, Teledyne Scientific & Imaging truly made their device corrosion free by placing all the parts inside a hermetically sealed buoy. They developed a mass-spring system to directly convert the heave motion of waves into relative linear motion between a stator (fixed to the buoy) and a translator (suspended to a spring). However, this device can only generate electricity at one specified wave frequency, not in a frequency range as for real waves. Besides, the short life span of the spring and the delicacy of their core enabling technique—a near-zero-friction liquid bearing, made their device hardly practical.

### SUMMARY

The present invention provides a wave energy converter that is completely encapsulated in a watertight and free-floating buoy. The only thing coming out of the buoy is a power transmission cable. The buoy is hydrodynamically designed so that it couples well with the undulating wave motion at all sea states. For energy harvesting, the mechanical energy from the angular oscillation of the buoy, not the heave motion, is utilized as the energy source. Inside the buoy, a permanent magnet linear generator is transformed into a circular shape and directly converts the mechanical energy into electricity. Specifically, an annular stator with a set of embedded coils is coaxially fixed to the cylindrical inner surface of the buoy. A wheel-like rotor with a set of magnets mounted to its rim is placed coaxially inside the stator. A rotation-retarding element, e.g., a heavy pendulum or a large rotary-inertia ring, is rigidly attached to the rotor at one end out of the stator chamber. The assembly of the rotor and the rotation-retarding element is supported by bearings on an arbor that is also coaxially fastened to the buoy. While in operation, the wave motion drives the stator to oscillate together with the buoy; of special interests is the rotary oscillation of the stator. On the other hand, the rotation-retarding element will attenuate in amplitude, and delay in phase, the rotary oscillation of the rotor. That results in the relative rotary oscillation between the stator and the rotor inside the watertight buoy.

The free-floating nature of the buoy makes the wave energy converter (WEC) to be very easily deployed, just as simple as anchoring a boat in any favorable locations. The watertight sealing of the buoy makes the WEC completely corrosion free. The unique design of the direct generator allows the WEC to harvest energy in all the weather conditions without system-safety concerns. The only wearing moving parts in the entire WEC system are a few bearings; the excellent durability of the bearings can make the WEC maintenance free in the designed lifespan, e.g., 10 to 15 years.

For applications, individual WEC can be used to power offshore observation platforms, surface and underwater vehicles, and remote sensors and instruments. In group, arrayed WECs form a wave farm. The wave farm can be placed either near shore (as the majority of the current techniques does) or in a remote ocean area (with much higher energy flux). For near shore placement, the generated power can be transmitted through an underwater cable to a land-based power grid. For remote placement, a site near to an obsolete offshore drilling platform would be a good option. The platform can serve as a hydrogen station. The harnessed energy will be stored in the form of hydrogen that can be distributed anywhere like gasoline.

### BRIEF DESCRIPTION OF THE DRAWINGS

A complete understanding of the method and apparatus of the present invention may be obtained by following the detailed description in conjunction with the accompanying drawings in which like reference numerals designate like parts throughout the drawings wherein:

FIG. 1 is an assembled view of the entire apparatus of the present invention;

FIG. 2 is an exploded view of the entire apparatus shown in FIG. 1;

FIGS. 3A through 3E schematically illustrate the principle of operation of the present invention;

FIGS. 4A and 4B show two different types of buoys in assembled views, with either one of them embodying the present invention;

FIGS. 5A and 5B are the exploded views of the two buoys shown in FIGS. 4A and 4B respectively;

FIGS. 6A and 6B show two different rotation-retarding subsystems in assembled views, with either one of them embodying the present invention;

FIG. 7 is the assembled view of one pair of stator-rotor configuration in working position;

FIG. 8 is the assembled view of a stator with a close-up showing more local details;

FIGS. 9A and 9B show the assembled view and exploded view of a rotor, respectively.

### DETAILED DESCRIPTION OF THE PREFERRED EMBODIMENTS

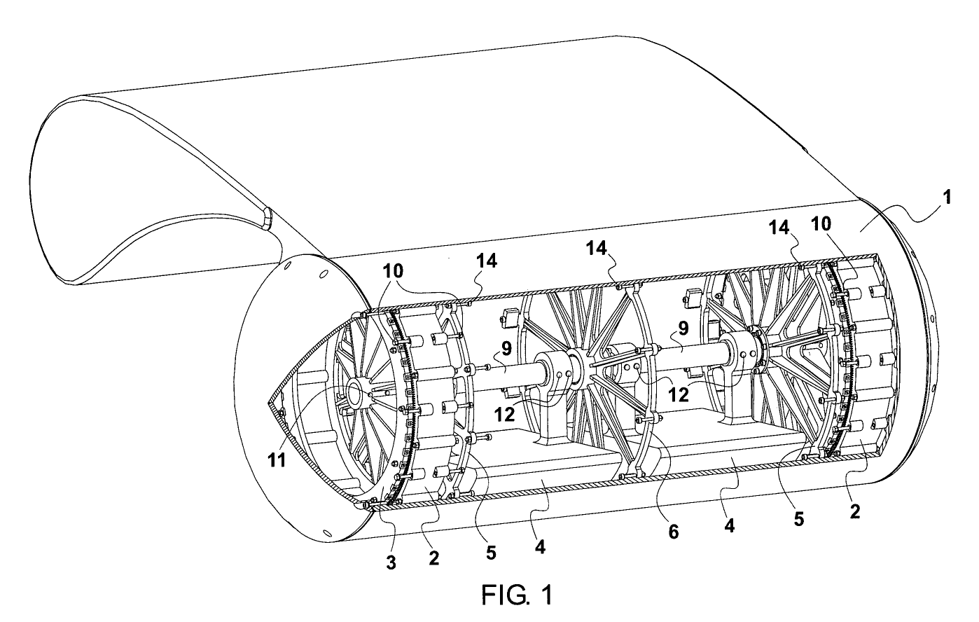

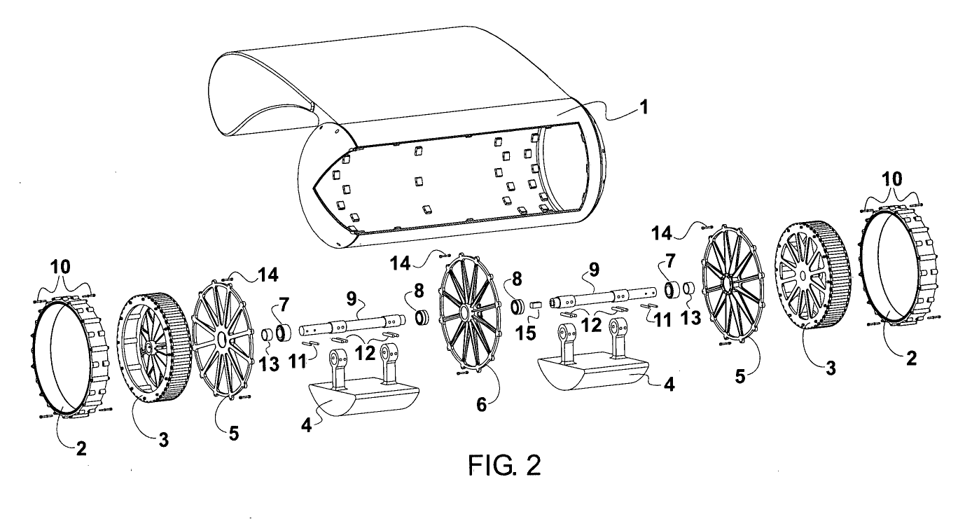

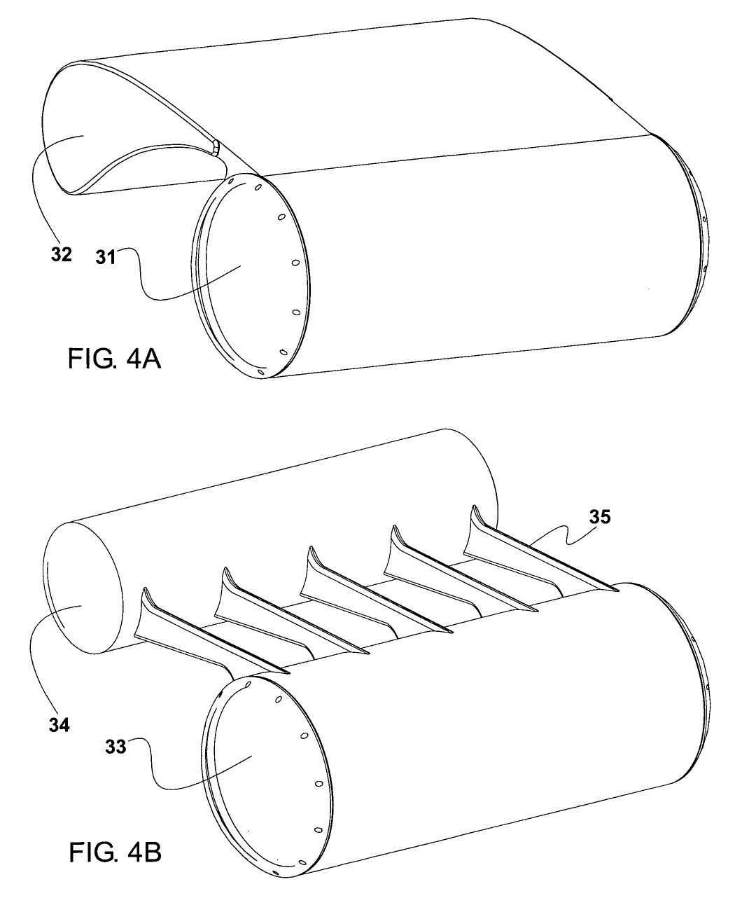

The overall configuration of the WEC to the present invention is shown in FIG. 1 in assembled view and FIG. 2 in exploded view (to subsystem level only). Details on subsystem components are provided in FIGS. 4 through 9. As shown in FIGS. 1 and 2, the major components of the WEC are a buoy 1, stators 2 in pair with rotors 3 and rotation-retarding units, such as a pendulum 4, supporting wheels 5 and 6, bearings 7 and 8, and arbors 9. Any suitable rotation-retarding units can be employed in accordance with the principles of the present invention, such as a cylinder, a pendulum, or any other element that serves to slow the inertia of the rotor, or the motion of the rotor relative to the seabed. Further, the rotor could be slowed by applying elements that slow the rotation of the rotor applying a combination of different physical principles, such as a pendulum combined with a cylinder. The ring-shaped stators 2 are tightly fixed to the cylindrical inner wall of the buoy 1 using fasteners 10. A rotor 3, a pendulum 4 and a stepped arbor 9 are rigidly assembled through pins 11 and 12. The bearings 7 are positioned to the arbors 9 by stop sleeves 13 and steps on the arbor. The supporting wheels 5 and 6 house the bearings 7 and 8 respectively and therefore provide support to all the components assembled to the arbors 9, and maintain coaxiality of the arbors 9 to the cylindrical inner wall of the buoy 1 after fixed to that inner wall of the buoy 1 using fasteners 14. The bearings 7 and 8 allow the assembly of the rotors 3, the pendulums 4 and the arbors 9 to rotate/oscillate freely along the axis of the arbors 9.

The buoy 1 provides a watertight chamber that houses all the other parts and makes the entire apparatus corrosion free. The only thing reaching out of that watertight chamber will be a cable for power delivery (not shown).

The roller bearings 7 and 8 are the only wearing moving parts in the entire WEC. Under the designed working conditions with various sea states, high quality roller bearings can have a lifespan of a decade or two. That is comparable with the lifespan of the other parts in this apparatus as a consequence of aging and/or fatigue damage. Therefore, in the designed lifespan the WEC will be maintenance free.

For the WEC presented in FIGS. 1 and 2, a combination of two units with each consisting of a stator 2, a rotor 3, a pendulum 4 and an arbor 9 is adopted. The two arbors 9 are coupled by a key 15 to achieve synchronized rotary motion. However, the configuration of the apparatus for present invention is not limited to this two-unit arrangement. It can be single unit or multiple units. The axial arrangement (along the arbors 9) of the components can also be flexible. The design of a specific configuration will largely depend on the application conditions, and some general criteria need to be followed to achieve the best design. A selected configuration should be in favor of easy assembly of parts and subsystems in regard of weight, size and complexity. A selected configuration should also be in favor of satisfactory mass distribution and sufficient natural cooling while in operation. And above all, a selected configuration should yield a WEC that is energy-efficient and cost-effective.

The drawings in FIGS. 1 and 2, as well as in FIGS. 4 through 9, are all made in scale. They refer to the dimensions of the cylindrical chamber in the buoy 1 that are 1 m in diameter and 2 m long. The design of the present invention can be scaled up or scaled down to meet various application needs.

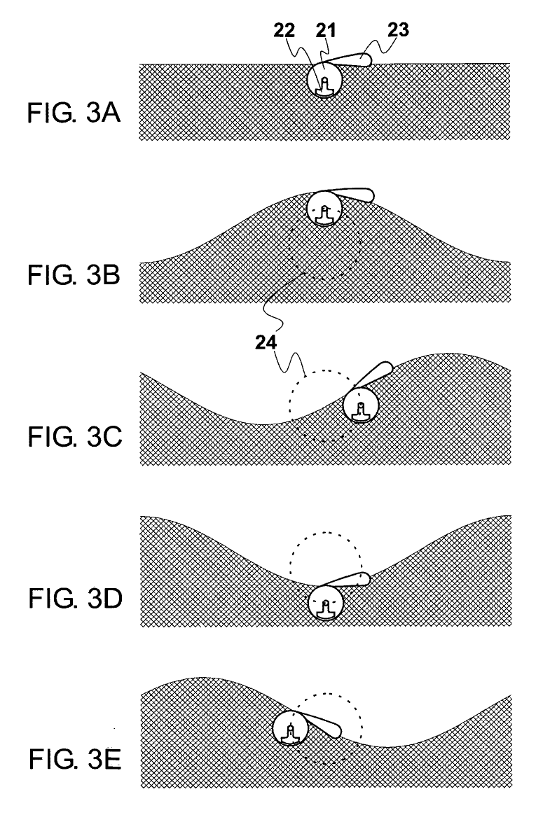

Before further description on the structural details, it is important to better understand the principle of operation of the present invention. A series of cartoon illustrations FIGS. 3A through 3E serve this purpose. To emphasize the discussion focus, in this cartoon series the complex structure of the present invention is symbolized by two parts only—a buoy 21 and a pendulum 22. The buoy 21 represents the combination of the buoy 1 and the stators 2 in the real apparatus as shown in FIGS. 1 and 2, and the pendulum 22 represents the combination of the rotors 3 and the pendulums 4 in FIGS. 1 and 2. Note that the pendulum 22 is capable of free rotation with respect to the buoy 21 via bearings that are not illustrated. FIG. 3A shows the submerging condition of the apparatus in still water. Basically the cylindrical part of the buoy 21 that houses the pendulum 22 is almost fully submerged. In contrast, the wing-shaped extension 23 of the buoy 21 mostly remains above the waterline. While exposed in a periodic wave motion, as illustrated in FIGS. 3B through 3E, the entire WEC will perform orbital translation along a virtual path 24. In addition, the wing-shaped extension 23 will force the buoy 21 to perform angular/rotary oscillation due to the water surface variation. Similarly, the pendulum 22 will also perform rotary oscillation, but in much lower amplitude and under different driving forces. On one hand, the rotary oscillation of the buoy 21 tends to force the pendulum 22 to follow due to the induced electromagnetic force from the relative motion of the stators 2 and the rotors 3 (referring to FIGS. 1 and 2). On the other hand, the large moment of inertia of the pendulum 22 (mainly from rotor 3 in FIGS. 1 and 2) makes it hard to follow the rotary oscillation of the buoy 21 (the rotary-inertia mechanism), and the large restoring moment load in an off-equilibrium position due to severely eccentric mass distribution tends to keep the pendulum 22 remaining in its equilibrium position (the pendulum mechanism). There is one more factor that contributes to the rotary oscillation of the pendulum 22; that is the inertia effect of the eccentrically distributed mass from the orbital translation of the pendulum 22. Overall, by accounting for all these factors and optimizing the design, the rotary oscillation amplitude of the pendulum 22 can be minimized and favorable range of phase difference with respect to the rotary oscillation of the buoy 21 can be achieved.

In principle, relative motion between the buoy 21 and the pendulum 22 in the conceptual schematics in FIGS. 3A through 3E, or between the stators 2 and the rotors 3 in the real apparatus of the present invention as shown in FIGS. 1 and 2, is essential for energy conversion. For a given design of stator-rotor pairs that will be further discussed later on, joint efforts on two aspects are necessary to enhance such relative motion. One aspect is to optimize the design of the buoy 1 (referring to FIGS. 1 and 2) so that it can best couple with wave motion under all sea states and thus force the stators 2 to achieve the largest rotary oscillation. The other aspect is to optimize the design of the pendulums 4, or in a more general sense to optimize the design of some sort of rotation-retarding subsystem using pendulum mechanism and/or rotary-inertia mechanism, so that it can minimize the rotary oscillation of the rotors 3 and yield a favorable phase difference between the stators 2 and the rotors 3.

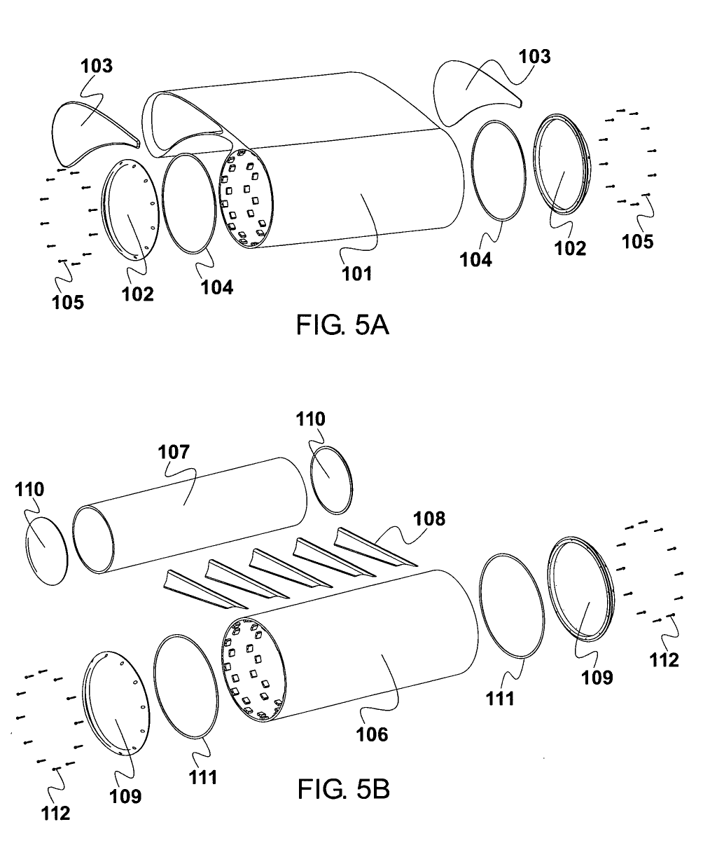

For buoy optimization, two typical shapes have been designed for the present invention. FIG. 4A shows the assembled view of one design that has been previously presented in FIGS. 1 and 2 as the buoy 1. It is an integrated hollow structure with a circular cylinder portion 31 housing the rest of the apparatus and an extended wing portion 32 providing the driving force for rotary oscillation. Alternatively, FIG. 4B shows the assembled view of another design. It is formed by two hollow cylinders 33 and 34 rigidly connected by crossbars 35, with the large circular cylinder 33 housing the rest of the apparatus and the small cylinder 34 providing the driving force for rotary oscillation. A variety of transformed shapes from these two designs can also be employed for buoy design in the present invention. FIGS. 5A and 5B illustrate the exploded views of the two buoys presented in FIGS. 4A and 4B, respectively. In FIG. 5A, the buoy consists of a main floating body 101, end covers 102 and 103, sealing washers 104 and fasteners 105. In FIG. 5B, the buoy comprises two hollow cylinders 106 and 107, crossbars 108, end covers 109 and 110, sealing washers 111 and fasteners 112.

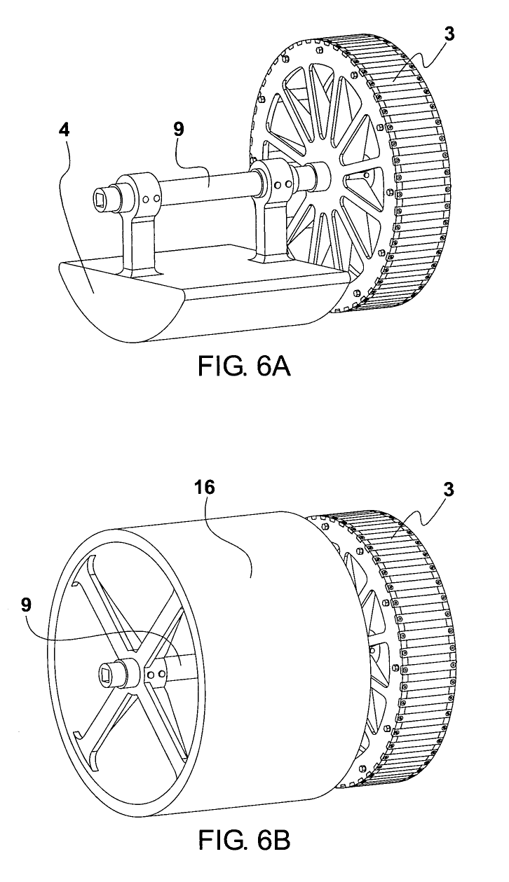

As with the optimization of the rotation-retarding subsystem, the aforementioned pendulum mechanism and the rotary-inertia mechanism can be applied either independently or jointly. FIG. 6A shows the assembled view of one rotation-retarding design that consists of a rotor 3, a pendulum 4 and an arbor 9, all assembled rigidly. This rotation-retarding design is actually a combination of pendulum mechanism (due to the pendulum 4) and rotary-inertia mechanism (due to the rotor 3), and it has been integrated in the apparatus shown in FIGS. 1 and 2. In contrast, FIG. 6B illustrated an alternative rotation-retarding design that only uses the rotary-inertia mechanism. It is realized simply by replacing the pendulum 4 in FIG. 6A with a rotary-inertia ring 16, and both the rotor 3 and the rotary-inertia ring 16 contribute to the overall moment of inertia. Other rotation-retarding designs of the present invention may include a combination of pendulums and rotary-inertia rings. In general, to serve the rotation-retarding purpose, a pendulum needs to possess distance from the center of mass to the rotation axis as long as possible and to posses mass as much as possible, and a rotary-inertia ring needs to possess moment of inertia as large as possible. However, for the apparatus of the present invention there are limitations on both mass and size due to the buoyancy requirement and space availability. In compliance with these limitations, materials with high density are preferred in making pendulums and rotary-inertia rings to meet high rotation retarding needs. By balancing the cost and the density, cast iron is one suitable candidate among other materials.

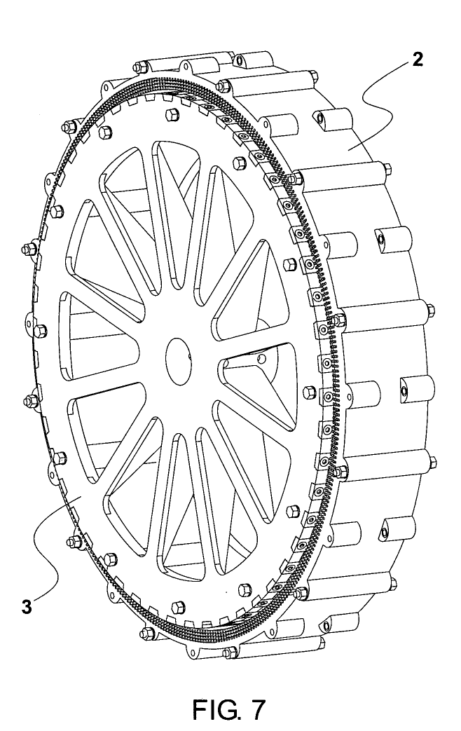

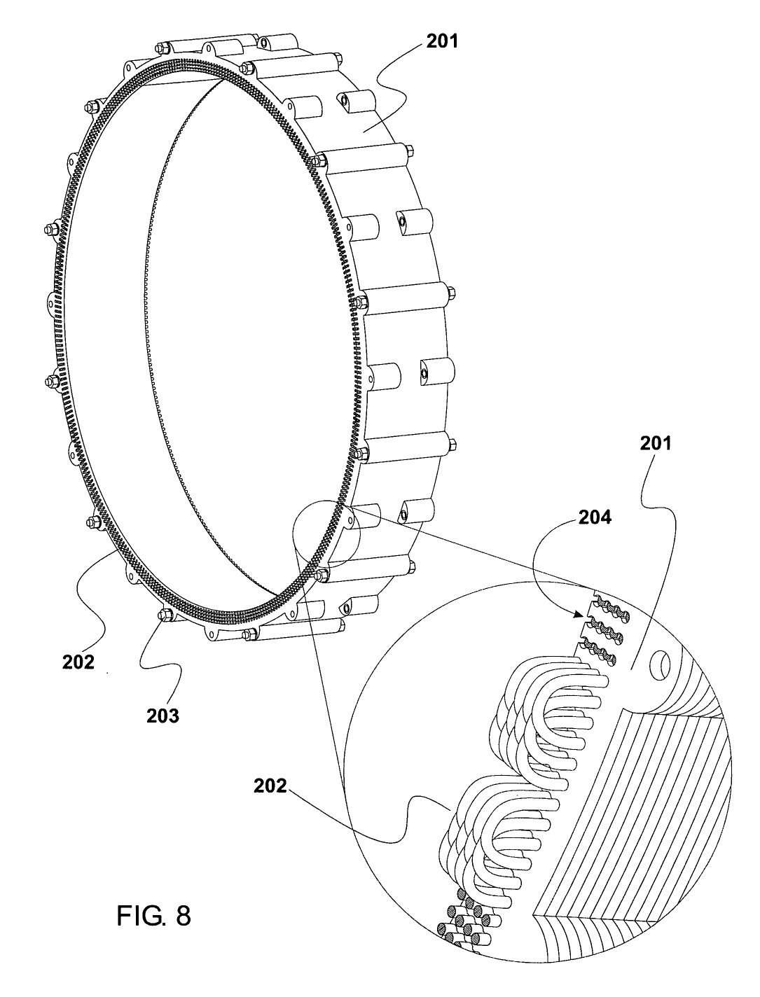

For generation of electricity, the principle of electromagnetic induction is applied by employing stator-rotor pairs. FIG. 7 shows one pair of stator-rotor configuration in working position. Recall that the stator 2 is tightly fixed to the inner surface of the buoy 1 (referring to FIG. 1), the rotor 3 is rigidly mounted to the arbor 9 (also referring to FIG. 1), and the rotor 3 is capable of free rotation/oscillation with respect to the stator 2. There is a small gap between the inner surface of the stator 2 and the outer surface of the rotor 3. The free rotation/oscillation feature between the stator 2 and the rotor 3 allows the WEC to work safely even under severe weather conditions without any protection. The detailed structure of the stator 2 is illustrated in FIG. 8 in assembled view. It consists of a pile of laminated electrical steel 201 in a ring shape, a set of conductive coils 202, and some fasteners 203 that hold the laminated electrical steel pile 201 together. The close-up in FIG. 8 shows the detailed shape of slots 204 on the electrical steel 201 and the winding configuration of the coils 202. Although it is known to provide a coil configuration to achieve a wave linear generator as discussed, for example, in Permanent magnet fixation concepts for linear generator, Oskar Danielsson, Karin Thorburn, Mikael Eriksson and Mats Leijon, Division for Electricity and Lightning Research, Department of Engineering Sciences, Uppsala University, Box 534, S-751 21 UPPSALA, the set of the conductive coils 202 follow the ring shape of the laminated electric steel 201 in accordance with the principles of the present invention. All the slots 204 go through the thickness of the electrical steel pile 201 along the centerline of the electrical steel pile 201.

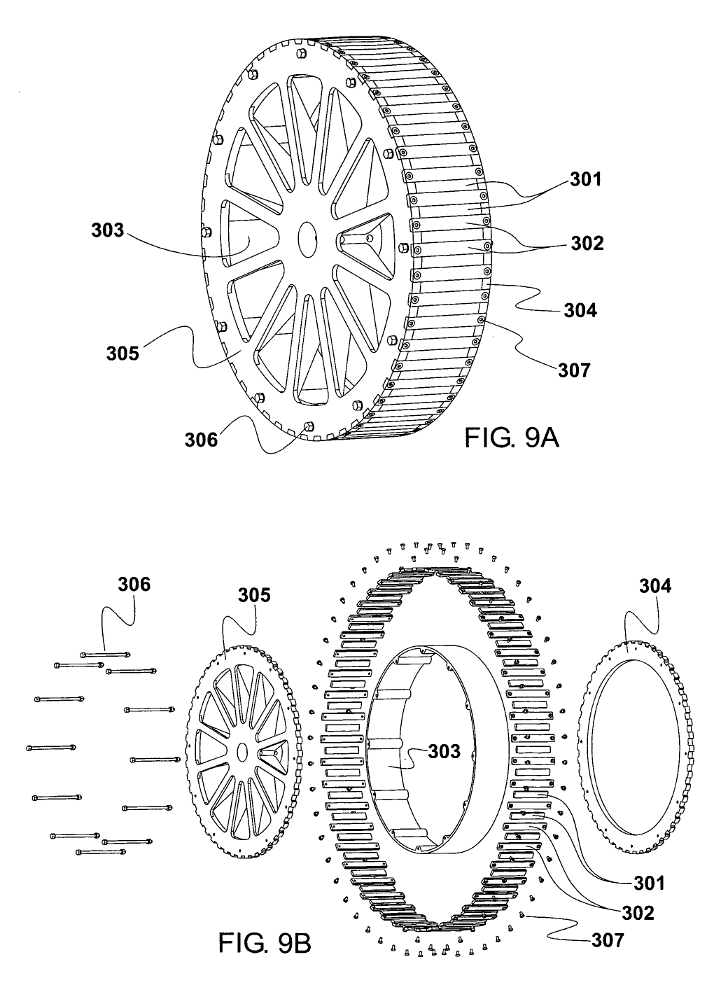

To match with the design of the stator coils, FIGS. 9A and 9B show the assembled view and exploded view of rotor design, respectively. A set of permanent magnets 301 and spacers 302 are laid out along the circumference of a back ring 303 in an alternating fashion. A side ring 304 and a hub 305 are coaxially mounted to the same back ring 303 via fasteners 306. The spacers 302 are fixed to the side ring 304 and the hub 305 using fasteners 307, and hold the permanent magnets 301 in position. For the same configuration of the rotor 3, there are two different arrangements in regard of polarity orientation of the magnets 301 as well as corresponding material selection of the spacers 302 and the back ring 303. One arrangement is to orient individual magnets 301 with polarity along the radius direction of the back ring 303, but with any two adjacent magnets 301 having opposite polarity orientations. Accordingly, the back ring 303 is made of some material like laminated electrical steel that is of low magnetic reluctance, and the spacers 302 is made of some material such as aluminum that blocks magnetic flux to pass through. Another arrangement is to orient individual magnets 301 with polarity along the tangential direction of the cross-section of the back ring 303. Again, any two adjacent magnets 301 have opposite polarity orientations. But material with high magnetic reluctance is needed for the back ring 303, and material with low magnetic reluctance is needed for the spacers 302. For both magnet arrangements mentioned above, aluminum is used to make the side ring 304 and the hub 305. Such aluminum structure reduces the leakage of magnetic flux and lowers the risk of magnet demagnetization due to unexpected external transients.

1. A wave energy converter comprising the following:
a buoy having an interior, the buoy being adapted and constructed to float on a body of fluid;
at least one stator fixed to a surface of the interior of the buoy;
at least one rotor mounted for oscillatory movement in the buoy interior at a location inside the at least one stator, wherein the rotor and the stator are separated by a very small gap to maximize energy production efficiency; and
at least one rotation-retarding unit connected to the at least one rotor,
whereby when the buoy is placed in a body of water in which wave action is present, the motion of the waves causes relative oscillation between the at least one rotor and the at least one stator to generate energy.

2. A wave energy converter in accordance with claim 1, wherein the buoy comprises a generally cylindrical housing.

3. A wave energy converter in accordance with claim 2, wherein the at least one stator comprises a plurality of stators secured to an interior surface of the cylindrical housing.

4. A wave energy converter in accordance with claim 3, wherein the at least one rotor comprises a plurality of rotors secured for oscillatory movement within the cylindrical housing.

5. A wave energy converter in accordance with claim 4, wherein the at least one rotation-retarding unit comprises at least one pendulum.

6. A wave energy converter in accordance with claim 5, further comprising an axial stepped arbor connecting the rotors to the housing.

7. A wave energy converter in accordance with claim 6, further comprising at least one supporting wheel secured to the arbor and in contact with the cylindrical housing.

8. A wave energy converter in accordance with claim 7, wherein each of the at least one supporting wheels is secured to the arbor by a respective bearing.

9. A wave energy converter in accordance with claim 1, further comprising a wing-shaped extension secured to the buoy.

10. A wave energy converter in accordance with claim 1, wherein the buoy comprises a first hollow cylinder containing the at least one rotor, the at least one stator, and a second hollow cylinder connected to the first hollow cylinder.

11. A wave energy converter in accordance with claim 1, wherein the at least one rotation-retarding unit comprises at least one rotary-inertia ring.

12. A wave energy converter in accordance with claim 1, wherein the at least one rotation-retarding unit comprises at least one rotary-inertia ring and at least one pendulum.

13. A wave energy converter comprising the following:
a buoy having an interior, the buoy being adapted and constructed to float on a body of fluid;
wing-shaped extension secured to the buoy;
a plurality of stators fixed to a surface of the interior of the buoy;
a plurality of rotors mounted for oscillatory movement in the buoy interior, each of the rotors being secured at a location adjacent to a corresponding stator; and
a plurality of rotation-retarding units connected to the plurality of rotors,
whereby, when the buoy is placed in a body of water in which wave action is present, the motion of the waves causes relative oscillation between the rotors and the stators to generate energy.

14. A wave energy converter in accordance with claim 13, wherein the buoy comprises at least one generally barrel-shaped housing.

15. A wave energy converter in accordance with claim 13, wherein each stator of the plurality of stators comprises an annular-shaped electrical steel ring having a slotted interior surface, wherein slots of the slotted interior surface are provided along the axis and distributed along the circumference of the stator.

16. A wave energy converter in accordance with claim 15, further comprising insulated conductors wound through the slots of the slotted interior surface of the stator.

17. A wave energy converter comprising the following:
a buoy having an interior, the buoy being adapted and constructed to float on a body of fluid and including a first hollow cylinder containing the at least one rotor, the at least one stator, and a second hollow cylinder connected to the first hollow cylinder;
a plurality of stators fixed to a surface of the interior of the buoy;
a plurality of rotors mounted for oscillatory movement in the buoy interior, each of the rotors being secured at a location inside a corresponding stator; and
a set of pendulums for retarding rotation of the plurality of rotors,
whereby, when the buoy is placed in a body of water in which wave action is present, the motion of the waves causes relative oscillation between the rotors and the stators to generate energy.

18. A wave energy converter in accordance with claim 17, each rotor of the plurality of rotors further comprising a set of permanent magnets, each rotor comprising an annular holder and spacers, wherein the spacers are provided for securing the adjacent magnets to the annular holder.

19. A wave energy converter in accordance with claim 18, wherein a polar end facet of the adjacent magnets is in contact with the holder, and wherein the holder is formed of a low magnetic reluctance material and the spacers are formed of a high magnetic reluctance material.

20. A wave energy converter in accordance with claim 18, wherein a polar end facet of the adjacent magnets is in contact with the spacers, and wherein the spacers formed of a low magnetic reluctance material and the holder is formed of a high magnetic reluctance material.
